(19) United States
(12) Patent Application Publication
(10) Pub. No.: US 2009/0282457 A1
(43) Pub. Date: Nov. 12, 2009

(54) COMMON REPRESENTATION FOR DIFFERENT PROTECTION ARCHITECTURES (CRPA)

(76) Inventor: Sudhakar Govindavajhala, Edison, NJ (US)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/115,767

(22) Filed: May 6, 2008

(51) Int. Cl. G06F 21/00; H04L 9/32; G06F 17/00

(52) U.S. Cl. 726/1

(57) ABSTRACT

A method of representing security information of a host in a universal format, in a manner that is independent of the semantics and implementation details of the underlying operating system is disclosed. The method comprises of the steps of having a security information representation layer to represent security information, the security information representation layer further comprising of representing entity and user privilege security information; representing object security information; representing object dependencies; and representing vulnerability information.

### BACKGROUND

1. Technical Field

The embodiments herein generally relate to data processing systems, and, more particularly, to representing security related information for different protection architectures.

2. Description of the Related Art

Most of the modern day companies have vast networks with complex hardware and software interactions. Due to these interdependent relationships, network security is a problem of much wider scope than the security of the individual components. Secure software can be written, however it is only as secure as the programs which can access that software. A secure computer can be designed and implemented, but the computer can only be as secure as the hosts that can access and manipulate the machine over the network.

The security of a computer depends on two orthogonal elements: individual program security and host configuration. Different operating systems such as Linux, WindowsNT, WindowsXP use different paradigms to represent and enforce such protections. Operating systems such as Debian Linux rely on group based permissions, while Windows relies on access control lists.

There are host wide configuration elements such as group memberships, program configurations, and user settings which can affect the security of programs or users. At installation time, programs modify configuration elements that affect the security of all users and programs of the host. In particular, an installation program might open an attack path through a previously installed program. To increase the level of security, memberships of groups have to be carefully controlled. Adding an unauthorized user to a trusted group can result in a security breach. However, it is difficult to identify the authorized groups on a host.

System configuration vulnerabilities can cause security breaches. While each system has its vulnerabilities, the problem is exacerbated often by poorly available documentation which needs to span implementations. This often results in poorer security because programs end up requiring higher privileges than needed to be safe. For example, configuration information is stored via registry and security keys in the Windows based systems, while it is stored in “read-write-execute-setuid-setgid” style permissions in Linux based systems.

### SUMMARY

In view of the foregoing, embodiments herein provides a method and a program storage device for representing security information of a host in a universal format, in a manner that is independent of the semantics and implementation details of the underlying operating system, the method comprising the step of having a security information representation layer to represent security information, the step further comprising at least one of representing entity and user privilege security information; representing object security information; representing object dependencies; and representing vulnerability information.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates network complexity through an example network having multiple hosts with multiple operating systems (OS) where some of the nodes may be virtual nodes running insider a container host operating system;

FIG. 2 shows standard security layers of a host and a security information layer to abstract security information specific to the operating system on the host; and

FIG. 3 shows the security information blocks being handled by security information representation layer.

FIG. 4 shows a predicate representing the operating system;

FIG. 5 shows predicates to describe the account protection infrastructure in a system for a user;

FIG. 6 shows a predicate to represent information about the user;

FIG. 7 shows a predicate to represent resource information;

FIG. 8 shows a predicate to represent programs;

FIG. 9 shows a predicate to represent object dependencies;

FIG. 10 shows a predicate to represent protection information on objects;

FIG. 11 shows a predicate to translate between the machine identifiers and human identifiers;

FIG. 12 shows a predicate to represent a security descriptor;

FIG. 13 shows a predicate to model the decision making at a granularity of a single access control entry;

FIG. 14 shows a predicate to encode the credentials of the process requesting the access;

FIG. 15 shows a predicate to identify various resources on a host;

FIG. 16 shows a predicate to represent the principal and his/her token when the principal logs in;

FIG. 17 shows a predicate to represent that it is possible to escalate from one user/machine account to another user/machine account;

FIG. 18 shows a predicate to represent that it is possible to escalate from one user/machine account to another group account;

FIG. 19 shows a predicate to represent vulnerabilities in a program;

FIG. 20 shows a predicate to represent the properties of vulnerabilities in a program;

FIG. 21 shows a predicate to represent that a user or a group can escalate to another user or group;

FIG. 22 shows a predicate to specify that program acts as a shell; and

FIG. 23 shows a predicate to represent trust relationships.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

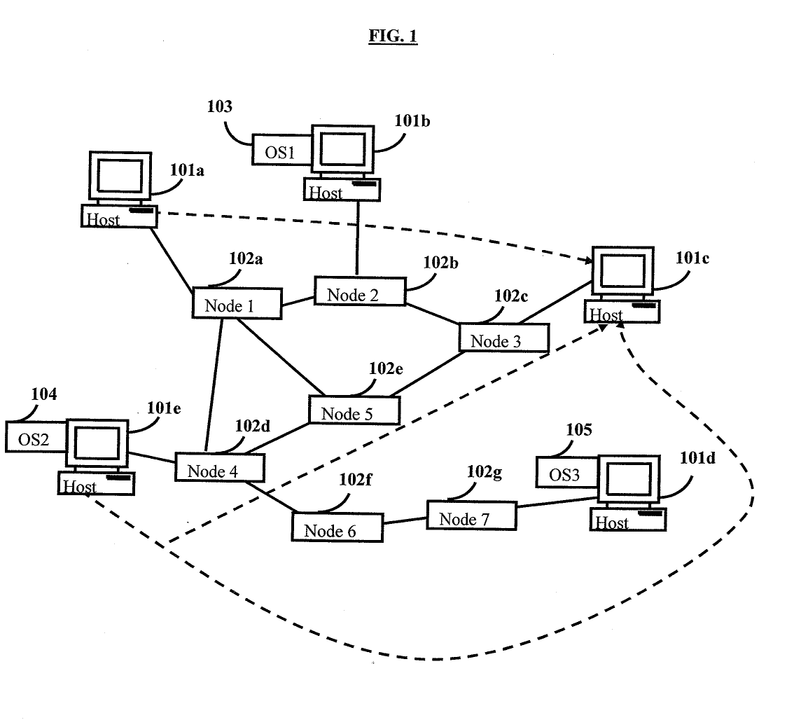

The embodiments herein achieve a common representation of security infrastructure across different protection architectures by providing a method of representing security related information of a host, in a manner that is transparent to the semantics and implementation details of the underlying operating system. Referring now to the drawings, and more particularly to FIGS. 1 through 23, where similar reference characters denote corresponding features consistently throughout the figures, there are shown preferred embodiments.

FIG. 1 illustrates network complexity in an example network having multiple hosts 101a, 101b, 101c, 101d and 101e with multiple operating systems (OS) 103, 104, and 105. The hosts 101a, 101b, 101c, 101d and 101e are computers connected to a network and host information and software. The software present on a host may be client software or server software. The nodes 102a, 102b, 102c, 102d, 102e, 102f, and 102g represent intermediate communications points, where the nodes may be computers, virtualized systems inside another host computer, personal digital assistants and other various network appliances such as routers, firewalls, wireless access points, switches and hubs. On a large network, where the number of configuration elements and their interactions between various elements is large, managing security is a complex and difficult task. System administrators are forced to securely configure hosts running different operating systems to inter-operate. These operating systems have different semantics and one needs to be careful to ensure that the differing semantics are mapped properly.

Security analyzers are commonly used to identify security problems on systems and networks. Security analyzers depend on host operating systems and other network elements like firewall to obtain security information for further processing. The security of a computer depends on two orthogonal elements: individual program security and host configuration. Different operating systems such as Unix like systems, Windows NT, Windows XP use different paradigms to represent and enforce such protections. Unix like systems are operating systems that behave in a similar manner to Unix and comprises of HP-UX, Red Hat Linux, Debian Linux, Fedora, Ubuntu, Novell NetWare, AIX, Suse Linux, Solaris OpenSolaris, OpenBSD. Operating systems such as Debian Linux rely on group based permissions, while Windows relies on access control lists. In group based permissions, permissions are given according to the user or user groups. The user or user groups are assigned permissions and categorized according to the level of access available to them. Restrictions may be placed on viewing, creating and editing content. Access control lists are lists of permissions attached to a component. The lists specify who or what is allowed to access the component and what operations are allowed to be performed on the component. In a network, the component may be a service port or network daemon names that are available on a host. Each component has a list of hosts and/or networks permitted to use the component. Some Unix systems rely on a combination of group based permission and access control lists.

There are host wide configuration elements such as group memberships, program configurations, and user settings which can affect the security of programs or users. At installation time, programs modify configuration elements that affect the security of all users and programs of the host. In particular, an installation program might open an attack path through a previously installed program. To increase the level of security, memberships of groups have to be carefully controlled. Adding an unauthorized user to a trusted group can result in a security breach.

System configuration vulnerabilities can cause security breaches. While each system has its vulnerabilities, the problem is exacerbated often by poorly available documentation which needs to span implementations. This often results in poorer security because programs end up requiring higher privileges than needed to be safe. For example, configuration information is stored via registry and security keys in the Windows based systems, while it is stored as file permission bits in Unix like systems.

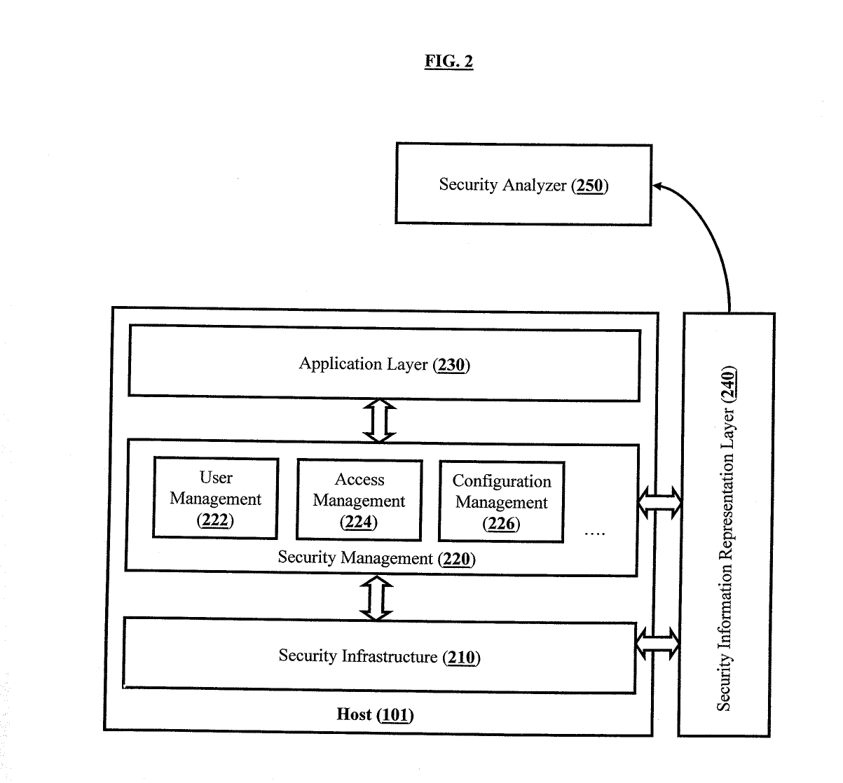

FIG. 2 shows an example host (101) with security layers including a security infrastructure layer (210) and a security management layer (220). Also shown is an application layer on top of the security layers. The security management layer (220) among other modules may contain modules for user management (222), access management (224), and configuration management (226). User management (222) may be used to create new users/user groups in the network and assigning unique privileges to each user/user group account. Access management (224) may state the access users/user groups have to specific resources available on the network. Configuration management (226) is a detailed record of all the components of the network, including all hardware and software components of the network. The security infrastructure layer may contain infrastructure relating to authentication and authorization, and host configuration database. For example, in a host running Windows operating system, user management may include using user account and lockout policy information to allow or deny users to resources on a host; access management may include using access control lists to decide whether to provide a process or a user access to an object on a host; and configuration management may include using windows registry to determine behaviour of various programs. And as another example, in a host running Debian Linux, user management may include using user account, and group membership information to allow or deny users to resources on a host; access management may include using file permission information to decide to provide a process or a user access to an object on a host; and configuration management may include using system configuration in relevant system directories such as “/etc” to determine behaviour of various programs.

In various embodiments, a security information representation layer (240) allows for abstraction of the security implementation of any particular operating system on a host and presents a common representation of security information irrespective of the underlying security implementation. As shown in the figure, in one embodiment, the security information representation layer (240) presents a common representation to a security analyzer (250) thereby reducing the complexity of information collection and analysis. The security analyzer (250) captures security events on the network and logs the events, where the security analyzer (250) may be a stand alone security event reporting tool or a complete security management solution. The security analyzer (250) also performs analysis on the security event logs. The logs comprises records of actions and events that take place on the network components like hosts, nodes etc.

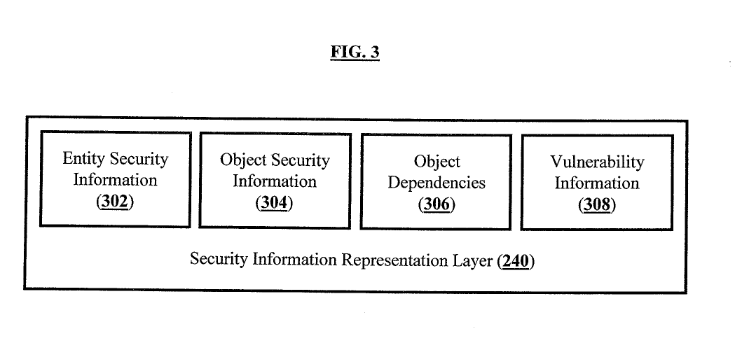

FIG. 3 illustrates in a block diagram, security information blocks that can be represented using security information representation layer (240). In various embodiments, the security information represented may include entity security information (302), object security information (304), object dependencies (306) and vulnerability information (308). Entity security information (302) may include security information relating to accounts, account lockout policies and groups information. Account lockout policies may be used to set thresholds to automatically shut down an account if too many incorrect username and password combinations are attempted. Object security information (304) may include information relating to security descriptors, access control lists, and file permissions. The security descriptor is automatically created along with the component on the network that is installed and controls the type of access allowed to the object for users and groups. Object dependencies (306) may include information relating to dependencies between various objects. For example, if an object references another object, then the ability to tamper the contents of the referred object will enable a malicious user to tamper the contents of the referring object. Vulnerability information (308) may include information relating to access check and privilege escalation. Access check checks if the user/user group is authorized to do what the user wants to do. Privilege escalation is the act of exploiting a loophole in a network component to gain access to the network which normally would have been protected from the user. The result is that the user performs actions with more privileges and has access to more data than intended by the network administrator.

A security predicate is a data structure that describes the various elements of the protection information associated with a computer. In various embodiments, security information may be represented using security predicates. Various security predicates, used to represent security information in a way that is transparent to the semantics and implementation details of the underlying operating system, are described hereafter.

Operating system is represented as OperatingSystem(Name) 400 as shown in FIG. 4. Here, “Name” 402, could be Windows XP/Vista/Windows NT, Unix like operating systems etc. Multiple operating systems are represented using multiple predicates wherein a host can run said multiple operating systems. The following predicate illustrates an example wherein a host runs both Windows XP and Red Hat Linux 6.2:

OperatingSystem(‘Windows XP’), and

OperatingSystem(‘Red Hat Linux 6.2’)

Account Lockout/Password Policy

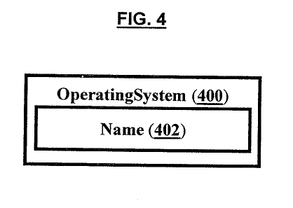

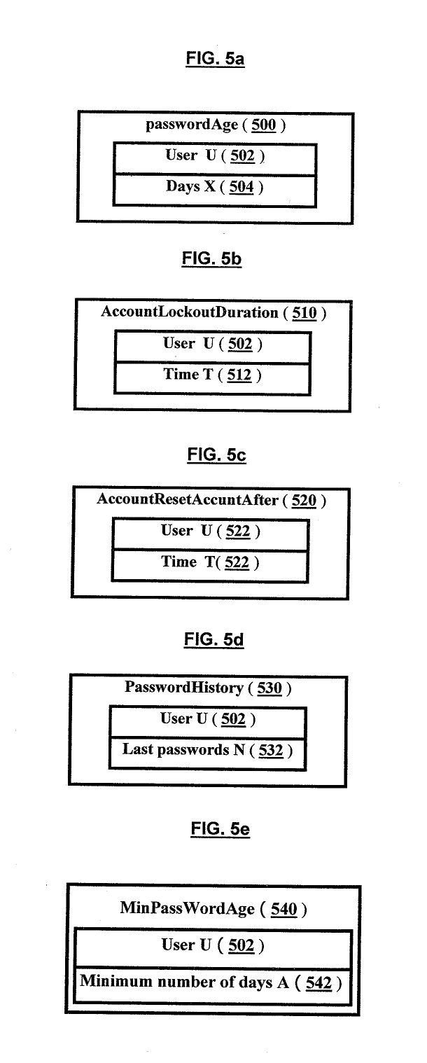

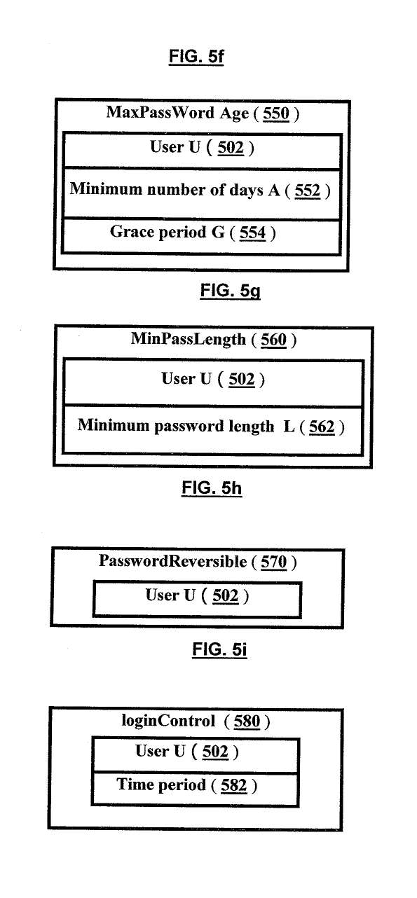

The following predicates as shown in FIGS. 5a-i are used to describe the account protection infrastructure in a system for a user, where the account protection infrastructure determines whether to grant the user access to components on the network:

1. passwordAge(U, X) 500, is used to specify that the password for the user U 502 should be changed after X days 504.

2. AccountLockoutDuration(U, T) 510 is used to specify that the account of user U 502 is locked out for time T 514 wherein said time is assigned the value −1 if the account is locked forever.

3. AccountResetAccuntAfter(U, T) 520 is used to specify that the account of user U 502, will be reset after time T 524, in the event of a lockout.

4. PasswordHistory(U, N) 530 is used to represent the N previous passwords 534 which cannot be used by the user U 502 as the password. Further, if the history is not checked, N can be assigned the value zero.

5. MinPassWordAge(U, A) 540 is used to specify that user U 502 has to use the password for a minimum number of days represented by A 542.

6. MaxPassWord Age (U, A, G) 550 is used to specify that the user U 502 has to change the password after completion of a number of days represented by A 552 wherein a grace period G 554 is allowed.

7. MinPassLength (U, L) 560 is used to specify that the user U 502 can assign a password having a minimum password length L.

8. PasswordReversible (U) 570 is used to specify that the user U 502 can store a password with appropriate reversible encryption method.

9. loginControl (U, TimePeriod) 580 is used to specify that a user U 502 can log on only during specified time interval. An example usage of this predicate is to say that a person Clerk can log on from 9 AM to 5 pm as loginControl (Clerk, TimePeriod(9 AM-5 pm)).

It will be clear to a person of skill in the art that one could replace a user with a group of users. For example, by defining a group G to comprise of users U1 and U2, one can specify that the minimum password length of U1 and U2 is 5 by using either predicate:

minPassLength(group(U1, U2), 5)
minPassLength(group(G), 5).

User Information

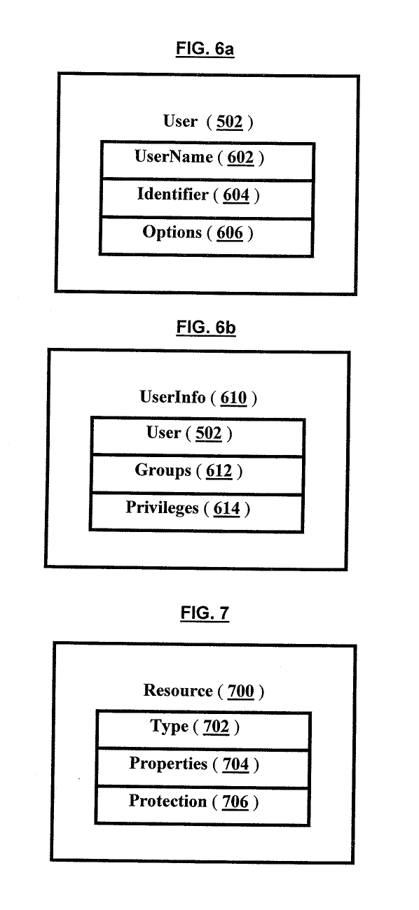

The information about said user in a system as shown in FIG. 6a is represented using the predicate as shown below:

User (UserName, Identifier, Options) 502 is used to specify that the UserName 602 is internally represented by the operating system by the identifier Identifier 604; further, Options 606 are used to specify meta information that may include information about the disablement of the user account. An example predicate as shown below specifies said user information for Windows operating system:

user(‘LocalSystem’, ‘S-1-5-18’, Options) and,

user ( ‘root’, 0, Options) is an example of said user information for Unix like systems.

userInfo(User, Groups, Privileges) 610 is used to specify that aparticular User U 502 is part of a set of listed Groups 612, and has Privileges 614 represents the privileges or capabilities of said user as shown in FIG. 6b. Further, Groups 612 can comprise of information about a group which includes information of said group being disabled or said user being a mandatorily part of the group. Further, Privileges 614 refer to the users' ability to conduct actions with system wide effects which include loading device drivers, ability to login, ability to take shutdown hosts, ability to take ownership of any resource on the host.

A user with administrative privileges is represented as member of administrative group “Administrators”. In case a group “Administrators” does not exist on the computer, the existence of a virtual administrators group is presumed.

Resource Information

When a computer or a program runs, it is the result of interactions between different objects in the operating system. Examples are the files that store the executable, the configuration files, the “registry keys” (in Windows) that supply configuration information, the operating system services that run by default when the computer starts, the various inter-process communication channels, processes, pipes, services, shared memory, IPC channels, files mailslots, etc.

FIG. 7 shows said objects which are represented using the tuple, Resource(Type, Properties, Protection) 700, wherein Type 702 includes but is not limited to service, file, registry key, process, mailslot, handle, socket, file descriptor, pipe, wmi_handle, interprocess communication primitive, and any other object category that is provided protection on the host. A tuple is an ordered set of values. The separator among values in a tuple may be a comma. Tuples are used for passing a string of parameters from one program to another and to represent a set of value attributes in a relational database. Tuples may be nested within other tuples using parentheses or brackets and may also contain a mixture of data types. An n-tuple refers to a tuple having n values within the tuple, where n is any non-negative integer. Properties 704 comprises of meta information about said resource, which may contain information including a name string associated with the resource and specific configuration properties of the resource that define its behavioral properties, Protection 706 is the identifying information for the protection on the resource.

An example tuple for resource representing a service is as follows:

Resource(service, serviceProp (name(‘ACPI’), displayName
(‘Microsoft ACPI Driver’), account (‘LocalSystem’), binPath
(‘c:\\windows\\system32\\drivers\\acpi.sys’) ), Protection)

An example predicate for files on a UNIX like system is

Resource(file, fileProp(name(iptables),
path(/usr/rc.d/init.d/iptables), Protection).

An example predicate for registry keys on a Windows system is

Resource(registry, registry( key(’HKLM\\Software\Key’),
value(’HelloWorld.dll’) ), Protection).

Resource 700 protection needs to take into account a multiplicity of factors which include to check if the protection is such as whether the protection is an access-control list, or traditional “rwx” style protection, where in “rwx” each bit stands for a specific type of access granted to user. For example, a user with “r_” has only access to read the resource, whereas a user with “rw_” has access to read and write (on) the resource, whereas a user with “rwx” has access to read, write and execute the resource. For example, it is very obvious that \\systemroot\\system32\\smss.exe refers to an executable file on a Windows based system.

Program Information

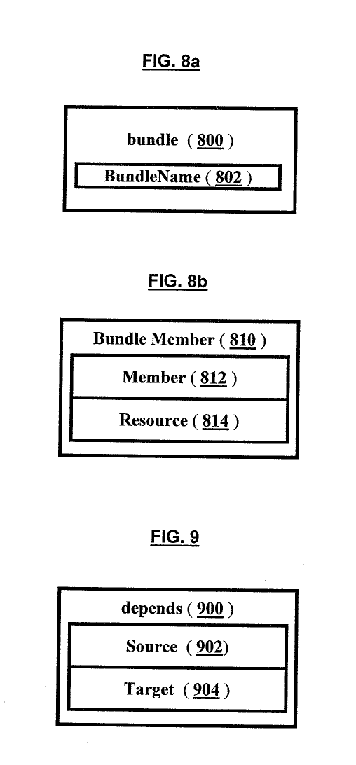

The representation of programs is as shown below as shown in FIG. 8a:

bundle (BundleName) 800 wherein examples of BundleName 802 are:

bundle (init)
bundle (dpkg) // Debian package manager
bundle (rpm) // Redhat package manager
bundle (’Adobe Acrobat7.0’)
bundle (mysql)

The list of all programs that are installed on a host can be obtained by using appropriate commands that vary depending on the version of operating system. For example, rpm -query -all for Red Hat Linux and dpkg -1 for Debian Linux. Further, the list of all files installed by a program can be obtained by using rpm -q <prog>—list in Red Hat Linux and dpkg -listfiles <package_name> in Debian Linux. Further, on a Windows machine, said list can be obtained by methods which includes but not limited to querying the Control Panel or Start Interface.

It is quite normal to have one program install a large number of files. For example, one program P may install 170 files. Instead of referring to a weakness present in 170 files belonging to the program P, embodiments herein refer to the weakness of the set of files as a whole belonging to P. Thus, instead of referring to individual programs, reference is made to a group of files represented by a common characteristic such as the application they belong to or the super directory they belong to.

Collection of programs as mentioned herein is referred to as “bundle”. A file F that is a member of bundle B is represented as bundleMember (B, Resource) 810 as shown in FIG. 8b. The example predicates of said bundleMember 810 are:

bundleMember(kernel, ‘/lib/modules/kabi-4.0-0’) representing module ‘/lib/modules/kabi-4.0-0’ of bundle “kernel”,

bundleMember (‘Adobe Acrobat7.0’, ‘Reader\AcroRd32.exe’) representing program ‘Reader\AcroRd32.exe’ of bundle “Adobe Acrobat7.0”,

bundleMember (‘Adobe Acrobat7.0, RegistryKey(‘HKLM\Acrobat’)) which represents the registry key ‘HKLM\Acrobat’ of bundle “Adobe Acrobat7.0”,

bundleMember (mysql, ‘/etc/my.cnf’) which represents the configuration file ‘/etc/my.cnf’ of bundle “mysql”,

bundleMember (mysql, ‘/usr/bin/msql2mysql’) which represents the program ‘/usr/bin/msql2mysql’ of bundle “mysql”,

bundleMember (mysql, ‘/usr/bin/mysql’) which represents the program ‘/usr/bin/mysql’ of bundle “mysql”.

Object Dependencies

A particular program “program.exe” may be using “library.lib” as a library or a configuration file to supply properties that control execution. An adversary might tamper “library.lib” which might facilitate said adversary to tamper the “program.exe”. An example of dependency of objects can be illustrated using an example wherein a software package A supplied in Linux may require another software package B. The object dependencies as illustrated by the example can be represented by the predicate as shown in FIG. 9.

depends(Source, Target)900 to say that Source 902 depends on Target 904. In a general case, two resources can depend on each other as illustrated by the following predicates wherein the resource Perl depends on resource RPM:

depends(Perl, RPM)

Another example of dependency is when the content of a key or resource or file refers to another resource. For example, if resource A refers to resource B, the ability to tamper resource B gives a malicious user the ability to tamper A too. Such dependencies can be represented as:

depends(A, B).

Object Protection through ACLs

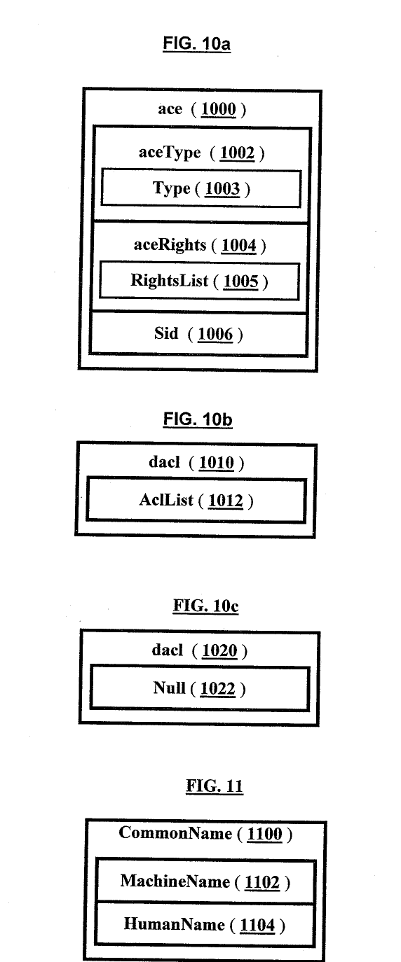

An access control entry is encoded as the primitive predicate as shown in FIG. 10a, ace(aceType(Type),aceRights (RightsList), Sid) 1000 that specifies that an access control entry of type Type 1003 wherein Type is one of ACCESS_ALLOWED_ACE_TYPE or ACCESS_DENIED_ACE_TYPE grants or denies to the entities represented by the identifier Sid 1006 the rights specified in the list RightsList 1005. An example usage is:

ace(aceType(’ACCESS_ALLOWED_ACE_TYPE’),
aceRights([’FILE_WRITE_DATA’]),
sid(’S-1-5-21-854245398-1637723038-725345543-1003’)).

With various objects types, appropriate aceRights 1004 needs to be chosen. For example, for a registry key a sample right is REGISTRY_KEY_WRITE, and for services a sample right is SERVICE_ALL_ACCESS.

In FIG. 10b, the predicate dacl (AclList) 1010 encodes an access control list (DACL), where AclList 1012 is a list of access control entry predicates, storing the entries in the same order as they appear in the security descriptor. The Discretionary Access Control List (DACL) is a list of access control entries. Each entry defines access permissions for a user or group of users. If no entry corresponds to a user in the DACL then access is denied. Further, protection may be encoded as dacl (null) 1020 wherein Null 1022 indicates that the object does not have any protection or “null DACL” as shown in FIG. 10c. If the object has an DACL of length zero, then the DACL is encoded as dacl ([ ] ). All other DACLs may be encoded as dacl ([HeadAce|ACLTail]) where HeadAce is a predicate that describes the first access control entry and ACLTail is a list of predicates for subsequent access control entries. An example DACL predicate may be as follows is:

dacl([
ace(aceType(’ACCESS_ALLOWED_ACE_TYPE’),
aceRights([’FILE_WRITE_DATA’]),
sid(’S-1-5-21-854245398-1637723038-725345543-1003’)),
ace(aceType(’ACCESS_ALLOWED_ACE_TYPE’),
aceRights([’FILE_READ_DATA’]),
sid(’S-1-5-21-854245398-1637723038-725345543-1003’))
])

This representation may also be used to encode UNIX file-permission information. The owner and group of a file is represented by security identifier 1003 and 500 respectively. The user has read, write and execute bits set, while in addition to these, the setgid bit is set. The third predicate encodes the permission information for the “world” in standard UNIX semantics. The file permissions of UNIX could be represented by a DACL of length three as follows:

```
    dacl([
    ace(aceType(’ACCESS_ALLOWED_ACE_TYPE’),
    aceRights([’read’, ’write’, ’execute’]),
    sid(’1003’)), ace(aceType(’ACCESS_ALLOWED_ACE_TYPE’),
    aceRights([’read’,  ’write’,  ’setgid’,  ’execute’]),
sid(’500’)), ace(aceType(’ACCESS_ALLOWED_ACE_TYPE’),
    aceRights([’read’,  ’write’,  ’setgid’,  ’execute’]),
sid(’world’))
    ])
```

For a person skilled it the art, it should be easy to see that this representation encodes permission information of many UNIX style operating systems including HP-UX, Red Hat Linux, Debian Linux, Solaris, OpenBSD.

For brevity, the description of elements of the model is at a high-level, and the details of the contents (for example, ACL) may vary according to implementation and operating system details. To illustrate that is model is generic, disclosed herein is how each individual access control entry on some systems is modeled. For example, a compiled description of an access control list may be represented depending on the context as:

```
    Windows:
    D:(A;;CCLCSWLOCRRC;;;AU)
(A;;CCLCSWRPWPDTLOCRRC;;;NO)
(A;;CCDCLCSWRPWPDTLOCRSDRCWDWO;;;BA)
(A;;CCLCSWRPWPDTLOCRRC;;;SY)
    or
    Linux:
    user::rw-
    user:alice:rw-
    group::r--
    group:bob:rw-
    mask::r--
    other::r--
```

The representation of an entity internal to the operating system MachineName 1102 is very different from the representation used by humans, HumanName 1104. For example, the user account “root” on a UNIX like system is represented by the identifier “0”. The group “Everyone” on a Windows operating system is represented by the identifier “S-1-1-0”, which in turn is represented in a machine language. Accordingly, the tuple commonName (MachineName, HumanName) 1100 as shown in FIG. 11 is used to translate between the machine identifiers and human identifiers, where the machine identifier is a substantially code unique to the machine and human identifiers may be a unique string unique to that particular human being. The human identifier may take the form of the email of the user, the domain name of the user, a username or other forms of human identifiers. For example, the mapping between machine identifiers and human readable identifiers may be represented depending on the context as:

commonName(S-1-5-6-7, BGoodman),

where “BGoodman” is the username to be provided to login. Similarly, in a Unix like system, an access control list may be represented as:

commonName(0, root),where “root” is the username.

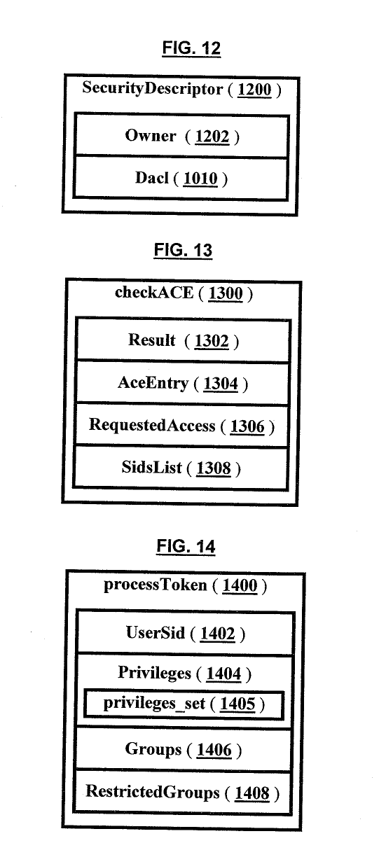

A security descriptor is encoded as the predicate securityDescriptor(Owner, Dacl) 1200 as shown in FIG. 12, where Owner 1202 represents the security identifier of the owner and Dacl 1010 is a predicate that encodes an access control list. When a kernel makes an access control decision, the decision will require the ability to decide the meaning of single access control entry.

The predicate checkACE(Result, AceEntry, RequestedAccess, SidsList) 1300 is the predicate that models the decision making at a granularity of a single access control entry as shown in FIG. 13 wherein Result 1302 can represent allowed or denied, AceEntry 1304 is an access control entry predicate, RequestedAccess 1306 is the requested access and SidsList 1308 is alist of security identifiers of the groups in the process token.

Process Credentials

When a principal accesses an object, the kernel looks up the process token of the process making the request to determine its credentials: the user, the privileges, the groups said user belongs to and the restricted groups said user belongs to. In FIG. 14, the predicate processToken(UserSid, Privileges, Groups, RestrictedGroups) 1400 encodes the credentials of the process requesting the access. UserSid 1402 is the identity of said user on behalf of whom the process runs, Privileges 1404 comprising of privileges-set 1405 wherein said set of privileges the process holds includes SeTakeOwnershipPrivilege, SeSystemtimePrivilege. SeTakeOwnershipPrivilege is assigned to administrators, and it lets the administartor act as if he had WRITE_OWNER access to all resources in the network. With SeTakeOwnershipPrivilege, an administrator can take ownership of any resource, but cannot assign the right to another user. SeSystemtimePrivilege, controls the ability to set the system time. Groups 1406 is the set of groups said user belongs to and RestrictedGroups 1408 is the set of restricted groups the user belongs to or the set of restrictions that may be placed on the groups the user belongs to. A sample process token looks like:

```
    processToken(’S-1-5-21-1214440339-507921405-1060284298-
500’, privileges([
    ’SeBackupPrivilege’,
    ’SeChangeNotifyPrivilege’,
    ’SeSystemtimePrivilege’
    ]),
    groups([’S-1-1-0’,  ’S-1-2-0’,  ’S-1-5-11’,  ’S-1-5-32-
544’]),
    restrictedGroups([ ])
    )
```

SeBackupPrivilege allows a user to access any persistent object (file, folder, registry key, et al) on the computer. This is equivalent to giving the user the Read permission group to all objects on the entire system.

By capturing “privileges” in a process token, “capabilities” that are supported by operating systems can be represented. For example, on a Linux system the following capabilities are supported:

TABLE 1
Linux Capabilities Table

| | |
|---|---|
| CAP_CHO | Allow for the changing of file ownership |
| WN | |
| CAP_KILL | Allow the sending of signals to processes |
| | belonging to others |
| CAP_SET | Allow changing of the UID |
| UID | |
| CAP_NET_RAW | Allow use of raw sockets |

Features that amount to privileges or capabilities in other operating systems can be represented accordingly.

For example, privileges ([CAP_NET_RAW, CAP_KILL]) notes that these two privileges are assigned to above process. By making the representation process specific, situations may be modeled where processes of same user may have different capabilities and permissions. Also, flags may be incorporated to indicate enabled or disabled state of capabilities or privileges that are assigned, and so on.

The above representation may be used to represent a process token in other UNIX like systems. For example, the following process token represents that the user with userid 500 belonging to groups with groupids 110, 120 and 1511, and with privileges CAP_CHOWN, CAP_KILL, CAP_SETU1D, CAP_NET_RAW.

```
    processToken( ’500’,
privileges([ ’CAP_CHOWN’,  cap_kill,  ’cap_setuid’,
cap_net_raw’]),
    groups([’110’, ’120’, ’1511’]),
    restrictedGroups([ ])
    )
```

In a standard Unix like system, a user may belong to multiple groups, but at a given time belongs to only one of the groups. A user would switch from one group to another by typing the “newgroup” command. In various embodiments, the functionality of a user being able to switch between multiple groups by allowing multiple groups to be represented in the process token may be captured. For example, in the above process token, the user may switch between 110, 120 and 1511.

Making the representation process specific enables to model situations where different processes of same user may have different capabilities and permissions. Also, flags may be incorporated to see if the capabilities or privileges are assigned but not enabled, and so on. For a person skilled it the art, it is easy to see that this representation encodes permission information of many UNIX like operating systems including HP-UX, Red Hat Linux, Debian Linux, Solaris, Suse, OpenBSD.

Modeling Privilege Escalation

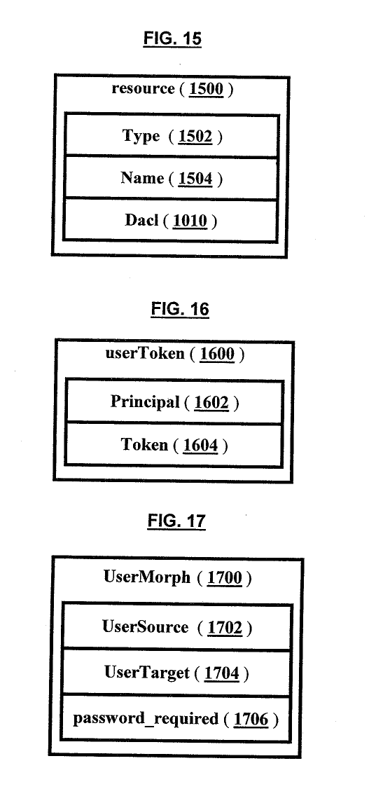

In FIG. 15, the predicate resource (Type, Name, Daci) 1500 is used to identify various resources on a host. Type 1502 indicates the type of the resource including but not limited to service, file, socket, message queue, shared memory identifier, registry key, process, mailslot, handle, file descriptor, pipe, wmi_handle, interprocess communication primitive, and any other object category that is provided protection on the host. Name 1504 identifies the resource and Daci 1010 is the protection on the resource. By scanning the host, one could generate the list of all the resources on a machine. The predicate userToken (Principal, Token) 1600 identifies that the principal Principal 1602 gets the process token Token 1604 when said user logs in as shown in FIG. 16.

In FIG. 17, UserMorph(UserSource, UserTarget, password_required) 1700 is used to represent that it is possible to escalate from user or machine account UserSource 1702 to user/machine account UserTarget 1704. On Linux based systems, for example, a user to change from one to the other, using the program sudo. The configuration file for sudo would result in a list of escalations, which will be represented using the above predicate. In other operating systems, there may be other programs which would allow such a transformation. Such escalations can be captured using the UserMorph predicate. Some of these escalations may or may not require a password, and that is represented using password_required 1706.

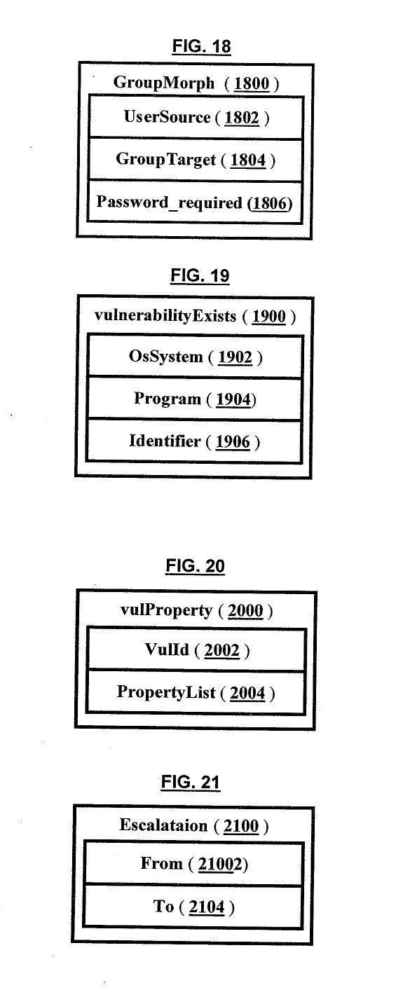

In FIG. 18, the predicate GroupMorph (UserSource, GroupTarget, password_required) 1800 is used to represent that it is possible to escalate from user or machine account UserSource 1802 to user/machine account GroupTarget 1804. On Linux based systems, for example, a user uses the program sudo to change from one to the other. The configuration file for sudo would result in a list of escalations, which will be represented using the above predicate. In other operating systems, there may be other programs which would allow such a transformation. Such escalations can be captured using the GroupMorph predicate. Some of these escalations may or may not require a password, and that is represented using password_required 1806.

userMorph (alice, bob, true) represents that with a password, alice can morph can bob

GroupMorph(alice, group(eve), false)//alice can morph to any member of group eve

GroupMorph(group(eve), group(alpha), true)//with a password, any member of eve can morph to any member of alpha group.

Vulnerability Representation

In various embodiments, existence of vulnerability in a file Program may be represented as shown in FIG. 19 by:

vulnerabilityExists(OsSystem, Program, Identifier) 1900

wherein a vulnerability identified by Identifier 1906 exists in Program 1904, and optionally the operating system OsSystem 1902 is specified. The vulnerability's property is specified as shown in FIG. 20 by

vulProperty(VulId, PropertyList) 2000 is used to represent that the vulnerability bearing identification number VulId 2002 has properties listed in the list PropertyList 2004. The individual contents of the property list are used to specify the properties associated with the vulnerability. Example values for the properties are shown below in Table 2 in various classes.

TABLE 2
Examples values of properties
Result of a malicious action

| | |
|---|---|
| serviceSlowdown | The target has become |
| | slow/unresponsive |
| Crash | The adversary can crash the |
| | program |
| applicationReboot | Can restart a particular |
| | application |
| operatingSystemReboot | Can reboot the operating system |
| userLoggedOut | Can log the user out |
| denialOfService | Deny service to the user |
| controlOfOSUserOfApplication | Allows unpreviliged user access |
| | to modify application |
| controlAdminuserOfApplication | Subversion of application |
| | enforced access controls |
| applicationCompromise | Misuse of privilege to gain |
| | direct access to protected |
| | system resources or to |
| | bypass application enforced |
| | access controls. Allows |
| | illegitimate access to |
| | system resources |
| operatingSystemCompromise | Allow attacker to execute code |
| | of his or her choice. |
| userSessionKilled | Terminate the user session |
| manipulateFile(File) | Can manipulate a particular file |
| | named File |
| privilegeEscalation | The malicious gets the control of |
| | application, its operating system |
| | context and the user running the |
| | application |
| informationLeakage | Allows attacker access to |
| | sensitive information |
| integrityCompromised | System is modified to act like or |
| | present the data that the attacker |
| | presents |
| directoryTraversal | Allows illegitimate access to |
| | files or data that the user |
| | does not normally have access |
| | to, *by traversing to parent |
| | folders etc |

Prerequisites

| | |
|---|---|
| remoteProblem | Vulnerability can be exploited |
| | from a remote node |
| localProblem | Problem can be exploited only |
| | after getting limited access to the |
| | node |
| needsAuthentication | A password or other identifying |
| | information is needed to launch |
| | the malicious activities |
| doesNotNeedAuthentication | A password or other identifying |
| | information is not needed to |
| | launch the malicious program |
| needLocalShell | A local shell is needed to launch |
| | the malicious program |
| needNetworkAccess | Network access is needed to |
| | launch the malicious program |
| needAccessToConsole | Access to the console is needed |
| | to launch the malicious program |
| mustBeLocallyLoggedIn | Local login is required to launch |
| | the malicious program |
| needToBePartOfGroup | Used to specify that only a |
| | specific group of users can |
| | launch an exploit |
| needsMaliciousDNSServer | A malicious DNS server is need |
| | to launch an exploit |
| needsPortOpened(Protocol/PortNumber) | Needs a specific port to be open |
| | to launch the exploit |
| malicousUserneedsControlOfDirectory | Needs control of a specific |
| | directory to lunch the exploit |
| automaticallyExploited or | Needs action from the user to |
| userInterventionNeeded or | launch the exploit |
| automaticClientSideServer or userDumb | |
| needsModule(module) | Needs a particular module level |
| | to be enabled |
| targetNeedsToVisitSite | Specified as directory, network |
| | share, website, etc. |
| needToRunAParticularProgram | A particular program needs to be |
| | run to launch the exploit |
| clientSideProblem | Client can get control of server |
| serverSideProblem | Server can get control of client |
| needConnectivityLevel(Value) | Value is link level, application |
| | level, samSubnet, |
| | applicationLevel, emailLevel, |
| | InstantMessagingLevel |

Launch of exploit

| | |
|---|---|
| AutomaticServer | |
| AutomaticClient | |
| frequentlyUsedProgram | Launched through a frequently |
| | used program |
| userIgnorance | Can be done by a user who does |
| | not know the system well |
| attackerSkillLevel(value) | Attack open to an attacker of |
| | given skill level |

Risk Assessment

| | |
|---|---|
| riskAssessmentLevel(Value) | Refers to the risk assessment |
| | value |
| exploitAvailable | Refers to the exploit available |
| attacksInWild | Refers to attacks being available |
| | to general public |

Work Arounds

| | |
|---|---|
| workarounds(Item) | Item is exemplarily one of |
| | firewallRule, disableModule, |
| | runMemoryPatch, |
| | applicationPatch, |
| | OperatingSystemPatch, |
| | disableApplication, disableUser |

Escalation Representation

A user may be able to get hold of the privileges associated with another user either because of valid reasons as specified by the administrator in appropriate configuration files such as “/etc/sudo” for “sudo” or because of malicious actions by a party with a intention to cheat. User or group A can escalate to a user or group B, and such escalation may be represented as shown in FIG. 21:

Escalation(From, To)

An example predicate is as follows:

Escalation(Bob, Alice) to say that Bob can escalate to Alice.

Group “Eve” may be represented as Group(Eve). For example Escalation(Group(Charlie), Alice) is used to represent that anyone in group Charlie can escalate to Alice. Similarly for Escalation(Group(Charlie, Group (Eve)).

In some cases, a user may be able to run a particular set of programs and may be represented with an additional argument to Escalation.

Escalation(Bob, Alice, Application) to specify that Bob can run Adobe application as Alice. In various embodiments, the arguments of this predicate may also be groups. In other embodiments, multiple list of programs may be represented using appropriate wild cards and regular expressions. An example is as follows:

Escalation(Bob, Alice, Application(/usr/bin/su [!-]*,
!/usr/bin/su root, /usr/bin/pas*))

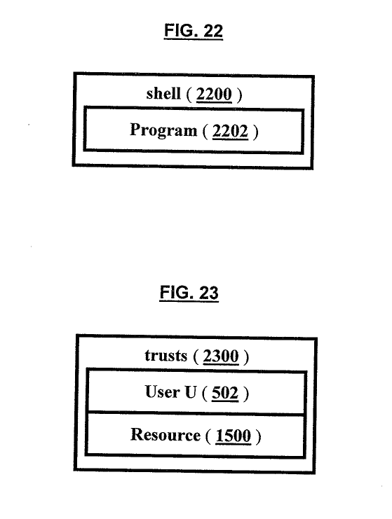

In FIG. 22, shell (Program) 2200 is used to specify that Program acts as a shell. The ability to execute Program 2202 on the machine gives a principal the ability to execute any program.

User Trust Relationships

When a user executes a program or application, he implicitly trusts the contents of the program. Similarly, when a program looks up a configuration setting like a registry key or a configuration file in “/etc” directory, and uses the setting to load a library or other wise change the behavior of the application, the ability to modify the setting allows a malicious party to get hold of the target user. For example, the ability to change the program executed by a Windows service usually results in a compromise of the administrative account of the system. Similarly, the ability to change the kernel of a UNIX like or Windows based operating system allows a malicious party to get hold of the administrative account of the host. Such trust relationships may be represented in various embodiments as shown in FIG. 23:

trusts(User, Resource) 2300

where resource Resource includes but is not limited to a program, resource, and a pointer to a program or a resource.

The ability of a malicious party to modify Resource 1500 will enable him to take control of the user User 502. For a group, User is replaced by group (Group). Example predicates are:

```
    Trusts(Administrator,
resource(registryKey(”HKLM\Software”))), and
    Trusts(Administrator, resource(file(/usr/bin/kernel))).
```

CRPA is a universal representation of the security architecture of a computer that is transparent to the underlying security architecture. CRPA enables creation of universal tools that can analyze the system transparent to the implementation specifics.

This representation not only represents internal host protections for many operating systems in a universal format, the representation also covers and abstracts the quirks in the various implementations. Also, CRPA covers group privilege protection representation. In addition, CRPA also covers configuration vulnerabilities and provides a universal representation of this infrastructure.

The embodiments disclosed herein can take the form of an entirely hardware embodiment, an entirely software embodiment or an embodiment including both hardware and software elements. The embodiments that are implemented in software include but are not limited to, firmware, resident software, microcode, etc.

Furthermore, the embodiments disclosed herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A method of representing security information of a host in a universal format, in a manner that is independent of the semantics and implementation details of the underlying operating system, the method comprising:
having a security information representation layer to represent security information, further comprising at least one of:
i. representing entity and user privilege security information;
ii. representing object security information;
iii. representing object dependencies;
iv. representing vulnerability information; and
v. representing privilege escalation information.

2. A method as in claim 1, where an operating system on a host is represented using data structure comprising at least a field to represent the name of the operating system.

3. A method as in claim 1, where a resource on a host is represented using data structure comprising:
a first field to represent category of said resource;
a second field to represent meta information about said resource; and
a third field to represent information identifying protection on said resource.

4. A method as in claim 1, where a collection of resources associated with a program is represented using data structure comprising:
a first field to represent name of said program.

5. A method as in claim 1, where a member of a collection of resources associated with a program is represented using data structure comprising:
a first field to represent name of said program; and
a second field to represent name of said member.

6. A method as in claim 1, where a process token representing credentials of a process requesting access is represented using data structure comprising:
a first field to represent user identity on behalf of whom said process runs;
a second field to represent a set of privileges said requesting process holds;
a third field to represent a set of groups said user belongs to; and
a fourth field to represent a set of restrictions that may apply to the said combination of said user and said process.

7. A method as in claim 1, where representing entity privilege security information further comprises of representing account protection security information, and where password age policy of a user account is represented using data structure comprising:
a first field to represent said user; and
a second field to represent the maximum number of days after which the password of said user account is to be changed.

8. A method as in claim 1, where representing entity privilege security information further comprises of representing account protection security information, and where lock out policy of a user account account is represented using data structure comprising:
a first field to represent said user; and
a second field to represent lockout time for said account,
where a value of −1 for lockout time represents that said user account never locks out.

9. A method as in claim 1, where representing entity privilege security information further comprises of representing account protection security information, and where account reset policy of a user account is represented using data structure comprising:
a first field to represent said user;
a second field to represent time period after which said account will reset in case of a lockout.

10. A method as in claim 1, where representing entity privilege security information further comprises of representing account protection security information, and where password history policy of a user account is represented using data structure comprising:
a first field to represent said user; and
a second field to represent number of passwords that are checked for repetition for said user account,
where a value of zero for number of passwords checked indicates that the passwords are not checked.

11. A method as in claim 1, where representing entity privilege security information further comprises of representing account protection security information and where minimum password age policy of a user account is represented using data structure comprising:
a first field to represent said user; and
a second field to represent minimum number of days for which a password must be used for said user account.

12. A method as in claim 1, where representing entity privilege security information further comprises of representing account protection security information and where maximum password age policy of a user account is represented using data structure comprising:
a first field to represent said user;
a second field to represent maximum number of days for which a password is allowed to be used; and
a third field to represent grace period allowed for using the password beyond said allowed maximum number of days.

13. A method as in claim 1, where representing entity privilege security information further comprises of representing account protection security information and where minimum password length policy of a user account is represented using data structure comprising:
a first field to represent said user; and
a second field to represent minimum length of password that is required.

14. A method as in claim 1, where representing entity privilege security information further comprises of representing account protection security information and where use of reversible encryption method for a user account is represented using data structure comprising a first field to represent said user.

15. A method as in claim 1, where representing entity privilege security information further comprises of representing account protection security information and where control of period of login for a user account is represented using data structure comprising:
a first field to represent said user; and
a second field to represent a time period during which said user can login.

16. A method as in claim 1, where representing entity privilege security information further comprises of representing account protection security information, and where password age policy of a group of user accounts is represented using data structure comprising:
a first field to represent said group; and
a second field to represent the maximum number of days after which the password of said user accounts of said group is to be changed.

17. A method as in claim 1, where representing entity privilege security information further comprises of representing account protection security information, and where account lockout duration policy of a group of user accounts is represented using data structure comprising:
a first field to represent said group; and
a second field to represent lockout time for user accounts of said group,
where a value of −1 for lockout time represents forever.

18. A method as in claim 1, where representing entity privilege security information further comprises of representing account protection security information, and where account reset policy of a group of user accounts is represented using data structure comprising:
a first field to represent said group;
a second field to represent time period after which user accounts of said group will reset in case of a lockout.

19. A method as in claim 1, where representing entity privilege security information further comprises of representing account protection security information, and where password history policy of a group of user accounts is represented using data structure comprising:
a first field to represent said group; and
a second field to represent number of passwords that are checked for repetition for user accounts of said group,
where a value of zero for number of passwords checked indicates that the passwords are not checked.

20. A method as in claim 1, where representing entity privilege security information further comprises of representing account protection security information and where minimum password age policy of a group of user accounts is represented using data structure comprising:
a first field to represent said group; and
a second field to represent minimum number of days for which a password must be used for user accounts of said group.

21. A method as in claim 1, where representing entity privilege security information further comprises of representing account protection security information and where maximum password age policy of a group of user accounts is represented using data structure comprising:
a first field to represent said group;
a second field to represent maximum number of days for which a password is allowed to be used; and
a third field to represent grace period allowed for using the password beyond said allowed maximum number of days.

22. A method as in claim 1, where representing entity privilege security information further comprises of representing account protection security information and where minimum password length policy of a group of user accounts is represented using data structure comprising:
a first field to represent said group; and
a second field to represent minimum length of password that is required.

23. A method as in claim 1, where representing entity privilege security information further comprises of representing account protection security information and where use of reversible encryption method for a group of user accounts is represented using data structure comprising a first field to represent said group.

24. A method as in claim 1, where representing entity privilege security information further comprises of representing account protection security information and where control of period of login for a group of user accounts is represented using data structure comprising:
a first field to represent said group; and
a second field to represent a time period during which user accounts of said group can login.

25. A method as in claim 1, where representing entity privilege security information further comprises of representing user security information, and where a user is represented using data structure comprising:
a first field to represent name of said user;
a second field to represent identifier for said user used by underlying operating system of said host; and
a third field to represent meta information about said user.

26. A method as in claim 1, where representing entity privilege security information further comprises of representing user security information, and where a user account information is represented using data structure comprising:
a first field to represent said user;
a second field to represent plurality of groups to which said user belongs to; and
a third field to represent plurality of privileges available to said user.

27. A method as in claim 1, where representing object security information further comprises of representing access control lists using data structure comprising:
a plurality of access control entries, each access control entry further comprising:
a first field to represent identifier of a plurality of entities;
a second field to represent a plurality of rights that are granted or denied to said plurality of entities; and
a third field to represent type of access control entry indicating one among grant or denial of said plurality of rights to said plurality of entities.

28. A method as in claim 1, where representing security information of an object further comprises of representing object security descriptor using data structure comprising:
a first field to represent security identifier of owner of said object;
a second field to represent an access control list comprising a plurality of access control entries, each access control entry further comprising:
a first field to represent identifier of a plurality of entities;
a second field to represent a plurality of rights that are granted or denied to said plurality of entities; and
a third field to represent type of access control entry indicating one among grant or denial of said plurality of rights to said plurality of entities.

29. A method as in claim 1, where representing vulnerabilities further comprises of representing existence of vulnerability using data structure comprising:
a first field to represent operating system of said host;
a second field to represent program in which vulnerability exists; and
a third field to represent identifier of vulnerability existing in said program.

30. A method as in claim 1, where representing entity and user privilege security information further comprises of representing user token using data structure comprising:
a first field to represent principal;
a second field to represent process token.

31. A method as in claim 1, where representing privilege escalation information further comprises of representing escalation from one account to another account using data structure comprising:
a first field to represent source user or machine account from which escalation happens;
a second field to represent target user, group or machine account to which escalation happens; and
a third field to represent whether password is required or not for escalation.

32. A method as in claim 1, where representing privilege escalation information further comprises of representing escalation from one account to another account using data structure comprising:
a first field to represent source user or machine account from which escalation happens; and
a second field to represent target user, group or machine account to which escalation happens.

33. A method as in claim 1, where representing privilege escalation information further comprises representing escalation information using data structure:
a first field to represent one among user account, group account and machine account from which escalation happens, and
a second field to represent one among user account, group and machine account to which escalation happens.

34. A method as in claim 1, where representing privilege escalation information further comprises representing escalation information using predicate:
a first field to represent one among user account, group account and machine account from which escalation happens;
a second field to represent one among user account, group and machine account to which escalation happens; and
a third field to represent application or set of applications for which escalation happens.

35. A method as in claim 1, where representing privilege escalation information further comprises of representing trust relationships using data structure comprising:
a first field to represent one among user and group that trusts the integrity of a resource; and
a second field to represent resource that said one among user and group executes.

36. A method as in claim 1, where representing object dependencies further comprises of representing object dependencies using data structure comprising:
a first field to represent source object that depends on a target object; and
a second field to represent said target object.

37. A method as in claim 1, where representing vulnerability information further comprises representing vulnerability properties using data structure comprising:
a first field to represent vulnerability identifier;
a second field to represent a plurality of properties of said vulnerability.
where said second field represents at least one of the properties:
target program slowing down,
target program crashing,
target application reboots,
target operating system reboots,
user account of target program logged out,
user is prevented from using particular service,
the vulnerability circumvention results in access to modify the application program,
the vulnerability circumvention results in the subversion of application enforced controls,
circumvention illegitimate access to system resources,
operating system is compromised,
user session is killed,
certain files are manipulated,
the application is circumvented so to allow arbitrary code to execute,
sensitive information is leaked,
the directory structure of the file system can be traversed,
system's data integrity is compromised,
malicious actions can be conducted only if local access to the host is available,
malicious actions can be launched remotely,
network access is needed to launch the malicious activities,
access to console is required to launch the malicious activities,
a local login is needed to launch the attack,
malicious party needs to be a member of said groups,
malicious party needs control over certain directories,
certain ports need to be opened,
program can be exploited only with user intervention such as opening of files or message attachments,
certain modules need to be enabled,
the targeted user needs to visit certain websites or file system locations,
a particular program needs to be run launch the exploit,
client can get control of the server,
server can get control of the client,
application level, subnet level, email level, instant message level connectivity is required,
targeted program is a frequently used program,
malicious exploits are readily available, and
weakness can be remediated by applying a firewall rule, or disabling module, running memory patch, patching application or operating system, disabling application, or disabling user.

38. A program storage device readable by computer, tangibly embodying a program of instructions executable by said computer to perform a method of representing security information of a host in a universal format, in a manner that is independent of the semantics and implementation details of the underlying operating system, the method comprising:
having a security information representation layer to represent security information, further comprising at least one of:
i. representing entity and user privilege security information;
ii. representing object security information;
iii. representing object dependencies;
iv. representing vulnerability information; and
v. representing privilege escalation information.

39. The program storage device as in claim 38 where an operating system on a host is represented using data structure comprising at least a field to represent the name of the operating system.

40. The program storage device as in claim 38, where a resource on a host is represented using data structure comprising:
a first field to represent category of said resource;
a second field to represent meta information about said resource; and
a third field to represent information identifying protection on said resource.

41. The program storage device as in claim 38, where a collection of resources associated with a program is represented using data structure comprising:
a first field to represent name of said program.

42. The program storage device as in claim 38, where a member of a collection of resources associated with a program is represented using data structure comprising:
a first field to represent name of said program; and
a second field to represent name of said member.

43. The program storage device as in claim 38, where a process token representing credentials of a process requesting access is represented using data structure comprising:
a first field to represent user identity on behalf of whom said process runs;
a second field to represent a set of privileges said requesting process holds;
a third field to represent a set of groups said user belongs to; and
a fourth field to represent a set of restrictions that may apply to the said combination of said user and said process.

44. The program storage device as in claim 38, where representing entity privilege security information further comprises of representing account protection security information, and where password age policy of a user account is represented using data structure comprising:
a first field to represent said user; and
a second field to represent the maximum number of days after which the password of said user account is to be changed.

45. The program storage device as in claim 38, where representing entity privilege security information further comprises of representing account protection security information, and where lock out policy of a user account is represented using data structure comprising:
a first field to represent said user; and
a second field to represent lockout time for said account,
where a value of −1 for lockout time represents that said user account never locks out.

46. The program storage device as in claim 38, where representing entity privilege security information further comprises of representing account protection security information, and where account reset policy of a user account is represented using data structure comprising:
a first field to represent said user;
a second field to represent time period after which said account will reset in case of a lockout.

47. The program storage device as in claim 38, where representing entity privilege security information further comprises of representing account protection security information, and where password history policy of a user account is represented using data structure comprising:
a first field to represent said user; and
a second field to represent number of passwords that are checked for repetition for said user account,
where a value of zero for number of passwords checked indicates that the passwords are not checked.

48. The program storage device as in claim 38, where representing entity privilege security information further comprises of representing account protection security information and where minimum password age policy of a user account is represented using data structure comprising:
a first field to represent said user; and
a second field to represent minimum number of days for which a password must be used for said user account.

49. The program storage device as in claim 38, where representing entity privilege security information further comprises of representing account protection security information and where maximum password age policy of a user account is represented using data structure comprising:
a first field to represent said user;
a second field to represent maximum number of days for which a password is allowed to be used; and
a third field to represent grace period allowed for using the password beyond said allowed maximum number of days.

50. The program storage device as in claim 38, where representing entity privilege security information further comprises of representing account protection security information and where minimum password length policy of a user account is represented using data structure comprising:
a first field to represent said user; and
a second field to represent minimum length of password that is required.

51. The program storage device as in claim 38, where representing entity privilege security information further comprises of representing account protection security information and where use of reversible encryption method for a user account is represented using data structure comprising a first field to represent said user.

52. The program storage device as in claim 38, where representing entity privilege security information further comprises of representing account protection security information and where control of period of login for a user account is represented using data structure comprising:
a first field to represent said user; and
a second field to represent a time period during which said user can login.

53. The program storage device as in claim 38, where representing entity privilege security information further comprises of representing account protection security information, and where password age policy of a group of user accounts is represented using data structure comprising:
a first field to represent said group; and
a second field to represent the maximum number of days after which the password of said user accounts of said group is to be changed.

54. The program storage device as in claim 38, where representing entity privilege security information further comprises of representing account protection security information, and where account lockout duration policy of a group of user accounts is represented using data structure comprising:
a first field to represent said group; and
a second field to represent lockout time for user accounts of said group,
where a value of −1 for lockout time represents forever.

55. The program storage device as in claim 38, where representing entity privilege security information further comprises of representing account protection security information, and where account reset policy of a group of user accounts is represented using data structure comprising:
a first field to represent said group;
a second field to represent time period after which user accounts of said group will reset in case of a lockout.

56. The program storage device as in claim 38, where representing entity privilege security information further comprises of representing account protection security information, and where password history policy of a group of user accounts is represented using data structure comprising:
a first field to represent said group; and
a second field to represent number of passwords that are checked for repetition for user accounts of said group,
where a value of zero for number of passwords checked indicates that the passwords are not checked.

57. The program storage device as in claim 38, where representing entity privilege security information further comprises of representing account protection security information and where minimum password age policy of a group of user accounts is represented using data structure comprising:
a first field to represent said group; and
a second field to represent minimum number of days for which a password must be used for user accounts of said group.

58. The program storage device as in claim 38, where representing entity privilege security information further comprises of representing account protection security information and where maximum password age policy of a group of user accounts is represented using data structure comprising:
a first field to represent said group;
a second field to represent maximum number of days for which a password is allowed to be used; and
a third field to represent grace period allowed for using the password beyond said allowed maximum number of days.

59. The program storage device as in claim 38, where representing entity privilege security information further comprises of representing account protection security information and where minimum password length policy of a group of user accounts is represented using data structure comprising:
a first field to represent said group; and
a second field to represent minimum length of password that is required.

60. The program storage device as in claim 38, where representing entity privilege security information further comprises of representing account protection security information and where use of reversible encryption method for a group of user accounts is represented using data structure comprising a first field to represent said group.

61. The program storage device as in claim 38, where representing entity privilege security information further comprises of representing account protection security information and where control of period of login for a group of user accounts is represented using data structure comprising:
a first field to represent said group; and
a second field to represent a time period during which user accounts of said group can login.

62. The program storage device as in claim 38, where representing entity privilege security information further comprises of representing user security information, and where a user is represented using data structure comprising:
a first field to represent name of said user;
a second field to represent identifier for said user used by underlying operating system of said host; and
a third field to represent meta information about said user.

63. The program storage device as in claim 38, where representing entity privilege security information further comprises of representing user security information, and where a user account information is represented using data structure comprising:
a first field to represent said user;
a second field to represent plurality of groups to which said user belongs to; and
a third field to represent plurality of privileges available to said user.

64. The program storage device as in claim 38, where representing object security information further comprises of representing access control lists using data structure comprising:
a plurality of access control entries, each access control entry further comprising:
a. a first field to represent identifier of a plurality of entities;
b. a second field to represent a plurality of rights that are granted or denied to said plurality of entities; and
c. a third field to represent type of access control entry indicating one among grant or denial of said plurality of rights to said plurality of entities.

65. The program storage device as in claim 38, where representing security information of an object further comprises of representing object security descriptor using data structure comprising:
a first field to represent security identifier of owner of said object;
a second field to represent an access control list comprising a plurality of access control entries, each access control entry further comprising:
a first field to represent identifier of a plurality of entities;
a second field to represent a plurality of rights that are granted or denied to said plurality of entities; and
a third field to represent type of access control entry indicating one among grant or denial of said plurality of rights to said plurality of entities.

66. The program storage device as in claim 38, where representing vulnerabilities further comprises of representing existence of vulnerability using data structure comprising:
a first field to represent operating system of said host;
a second field to represent program in which vulnerability exists; and
a third field to represent identifier of vulnerability existing in said program.

67. The program storage device as in claim 38, where representing entity and user privilege security information further comprises of representing user token using data structure comprising:
a first field to represent principal;
a second field to represent process token.

68. The program storage device as in claim 38, where representing privilege escalation information further comprises of representing escalation from one account to another account using data structure comprising:
a first field to represent source user or machine account from which escalation happens;
a second field to represent target user, group or machine account to which escalation happens; and
a third field to represent whether password is required or not for escalation.

69. The program storage device as in claim 38, where representing privilege escalation information further comprises of representing escalation from one account to another account using data structure comprising:
a first field to represent source user or machine account from which escalation happens; and
a second field to represent target user, group or machine account to which escalation happens.

70. The program storage device as in claim 38, where representing privilege escalation information further comprises representing escalation information using data structure:
a first field to represent one among user account, group account and machine account from which escalation happens, and
a second field to represent one among user account, group and machine account to which escalation happens.

71. The program storage device as in claim 38, where representing privilege escalation information further comprises representing escalation information using predicate:
a first field to represent one among user account, group account and machine account from which escalation happens;
a second field to represent one among user account, group and machine account to which escalation happens; and
a third field to represent application or set of applications for which escalation happens.

72. The program storage device as in claim 38, where representing privilege escalation information further comprises of representing trust relationships using data structure comprising:
a first field to represent one among user and group that trusts the integrity of a resource; and
a second field to represent resource that said one among user and group executes.

73. The program storage device as in claim 38, where representing object dependencies further comprises of representing object dependencies using data structure comprising:
a first field to represent source object that depends on a target object; and
a second field to represent said target object.

74. The program storage device as in claim 38, where representing vulnerability information further comprises representing vulnerability properties using data structure comprising:
a first field to represent vulnerability identifier;
a second field to represent a plurality of properties of said vulnerability.
where said second field represents at least one of the properties:
target program slowing down,
target program crashing,
target application reboots,
target operating system reboots,
user account of target program logged out,
user is prevented from using particular service,
the vulnerability circumvention results in access to modify the application program,
the vulnerability circumvention results in the subversion of application enforced controls,
circumvention illegitimate access to system resources,
operating system is compromised,
user session is killed,
certain files are manipulated,
the application is circumvented so to allow arbitrary code to execute,
sensitive information is leaked,
the directory structure of the file system can be traversed,
system's data integrity is compromised,
malicious actions can be conducted only if local access to the host is available,
malicious actions can be launched remotely,
network access is needed to launch the malicious activities,
access to console is required to launch the malicious activities,
a local login is needed to launch the attack,
malicious party needs to be a member of said groups,
malicious party needs control over certain directories,
certain ports need to be opened,
program can be exploited only with user intervention such as opening of files or message attachments,
certain modules need to be enabled,
the targeted user needs to visit certain websites or file system locations,
a particular program needs to be run launch the exploit,
client can get control of the server,
server can get control of the client,
application level, subnet level, email level, instant message level connectivity is required,
targeted program is a frequently used program,
malicious exploits are readily available, and
weakness can be remediated by applying a firewall rule, or disabling module, running memory patch, patching application or operating system, disabling application, or disabling user.
